(19) United States
(12) Patent Application Publication
(10) Pub. No.: US 2024/0406316 A1
(43) Pub. Date: Dec. 5, 2024

(54) DYNAMIC PRESENTATION OF AUDIO TRANSCRIPTION FOR ELECTRONIC VOICE MESSAGING

(71) Applicant: Apple Inc., Cupertino, CA (US)

(72) Inventors: Pierre J. DE FILIPPIS, Los Gatos, CA (US); Ryan P. NIELSEN, Sunnyvale, CA (US); Russell S. GREER, Los Gatos, CA (US); Sasanka T. VEMURI, San Ramon, CA (US); Stephen A. KAC, Cupertino, CA (US); Karthick SANTHANAM, Campbell, CA (US); Nicolas WAGNER, Cupertino, CA (US); Erik D. HORNBERGER, Pittsburgh, PA (US)

(21) Appl. No.: 18/415,533

(22) Filed: Jan. 17, 2024

Related U.S. Application Data
(60) Provisional application No. 63/470,979, filed on Jun. 5, 2023.

(51) Int. Cl. H04M 3/533; H04M 3/48

(52) U.S. Cl. CPC H04M 3/53333; H04M 3/48

(57) ABSTRACT

Aspects of the subject technology provide for dynamic presentation of audio transcription for electronic voice messaging, such as an audio voice messaging session. During an electronic voice messaging session between a first device and a second device, the first device can receive an audio input. During the electronic voice messaging session between the first device and the second device, the first device can generate a transcription of the audio input. During the electronic voice messaging session between the first device and the second device, the first device can dynamically display the transcription.

### CROSS-REFERENCE TO RELATED APPLICATION(S)

This application claims the benefit of U.S. Provisional Application Ser. No. 63/470,979, entitled “DYNAMIC PRESENTATION OF AUDIO TRANSCRIPTION FOR ELECTRONIC VOICE MESSAGING,” and filed on Jun. 5, 2023, the disclosure of which is expressly incorporated by reference herein in its entirety.

### TECHNICAL FIELD

The present description relates generally to audio transcription, and more particularly, for example, to dynamic presentation of audio transcription for electronic voice messaging.

### BACKGROUND

Voicemail is a widely used communication feature that allows callers to leave recorded audio messages for recipients when they are unable to answer a phone call. It serves as a means to relay information, deliver messages, and facilitate communication when immediate interaction is not possible.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which electronic voice messaging with dynamic presentation of a transcription may be implemented in accordance with one or more implementations.

FIG. 2 illustrates a schematic view of an electronic device for providing dynamic presentation of a transcription during an electronic voice messaging session in accordance with one or more implementations.

FIG. 3 illustrates a schematic diagram showing an exemplary user interface view in which a transcription is displayed dynamically on an electronic device during an electronic voice messaging session in accordance with one or more implementations.

FIG. 4 illustrates a flow diagram of an example process for providing dynamic presentation of a transcription during an electronic voice messaging session in accordance with one or more implementations.

FIG. 5 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form to avoid obscuring the concepts of the subject technology.

Embodiments of the subject technology in the present disclosure provide for the generation of a live audio transcript of an in-progress voicemail, allowing a user of an electronic device to respond to a received phone call (e.g., that was forwarded to voicemail) based on the displayed live audio transcript. The live audio transcript can provide real-time text representation of the caller's speech, facilitating quick and efficient communication. By utilizing this feature, users can easily ascertain the identity of the caller and the purpose of the call, enhancing the overall user experience. In one or more implementations, the user can answer the call, e.g., based on the content of the transcript, while the voicemail is being recorded.

Embodiments of the subject technology in the present disclosure also provide for the handling of calls from unknown numbers. In prior approaches, incoming calls from unknown numbers were directed to the carrier's voicemail. Subsequently, users had to listen to the voicemail and then return the call based on the contents of the voicemail message as required. However, the subject technology provides for handling incoming calls from unknown numbers differently, providing a more streamlined approach. When a call is received from an unknown number, it can be selectively directed to the live voicemail system on the user device rather than to the carrier's voicemail. Consequently, the user device can automatically answer the call and play either a personal recorded greeting or a default greeting using a synthetic voice. The default greeting can inform the caller to leave a message, with the possibility that someone may see the message and pick up the call.

Substantially concurrently, the user device can display a transcription of the caller's speech, allowing the user to read the incoming message while maintaining the connection. Based on the transcription, the user can decide to pick up the call and engage in a live conversation, leveraging the information provided in the transcription, or let the call stay with voicemail. Upon receiving the voicemail, they can listen to it and return the call as needed based on the content of the voicemail message. This feature enhances the user experience by offering improved call management and convenience. If the user chooses to silence calls from unknown numbers, the unknown caller may be promptly directed to the live voicemail system, which can be accessed by the user if desired. In some aspects, the user device may not provide a notification when a call from an unknown number is received, but can provide a haptic response to indicate availability of the recording of a voice message. Furthermore, the live voicemail system can incorporate an evaluation of confidence in the transcription of the voice message content. In instances where the live voicemail system has low confidence in the accuracy of the transcription, the content may not be displayed on the user device. In one or more implementations, the subject system may forward any calls believed to be spam, e.g., based on a directory of known spam numbers, to the carrier voicemail.

Embodiments of the subject technology in the present disclosure also provide for intercepting an audio stream received at the user device and routing it through a transcription service, such as an on-device speech recognition model. Subsequently, the transcription service processes the audio and generates a set of text/utterances that can be dynamically displayed on the screen of the user device, continuously updated as new utterances are received. Each utterance can be assigned a confidence score. If the confidence score is not sufficiently high, it can be visually indicated with an underline, highlighting the uncertainty.

Generating the transcription at the electronic device at which the audio input is received (e.g., in contrast to sending an audio stream for transcription at a server or other external transcription service) can be advantageous because local voice data corresponding to the speaker of the audio input can be obtained, learned, and/or stored by the electronic device that receives the audio input, and used to improve the audio transcription. Because this local voice data is maintained locally and privacy-protected at the electronic device, the privacy of the user, the speaker of which the audio input pertains to, can be maintained while leveraging the local voice data for that user to improve the electronic device's ability to generate an accurate and/or complete transcription.

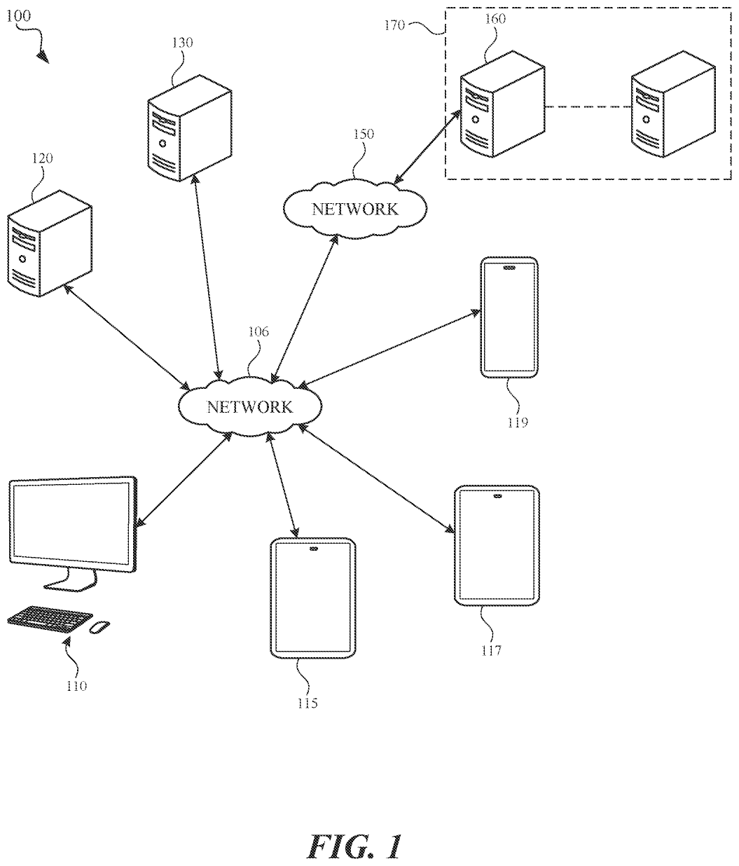

FIG. 1 illustrates an example network environment 100 in which electronic voice messaging with dynamic presentation of transcription may be implemented in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 115, an electronic device 117, an electronic device 119, a server 120, and a server 130. The network 106 may communicatively couple the electronic device 110, the electronic device 115, the electronic device 117, the electronic device 119, the server 120, and/or the server 130. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 115, the electronic device 117, the electronic device 119, the server 120, and the server 130; however, the network environment 100 may include any number of electronic devices and/or any number of servers communicatively coupled to each other directly or via network 106.

The server 160 may form all or part of a network of computers or a group of servers 170, such as in an access network implementation. For example, the server 170 stores data and software, and includes specific hardware (e.g., processors and other specialized or custom processors) for providing access to Internet protocol (IP) services, such as the Internet, an intranet, a streaming service, a cellular service, and/or other IP services. In an implementation, the group of servers 170 may function as part of a cellular service that provides wireless communications to the electronic device 110, the electronic device 115, the electronic device 117, and/or the electronic device 119. The network 150 may communicatively couple the group of servers 170 to the electronic device 110, the electronic device 115, the electronic device 117, the electronic device 119, the server 120, and/or the server 130 via the network 106. Although the network 106 and the network 150 are depicted as separate networks, these networks may form, and/or may include all or part of, a common network in other implementations.

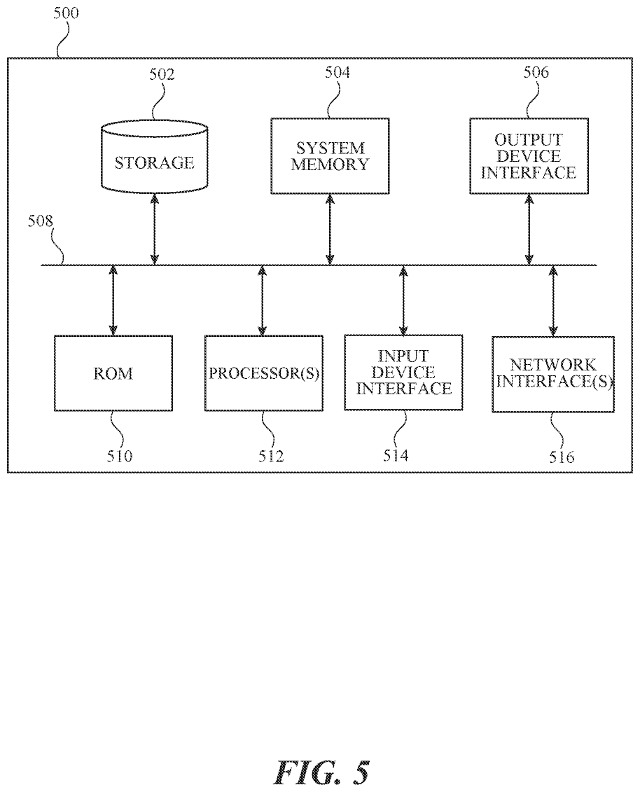

Any of the electronic device 110, the electronic device 115, the electronic device 117, or the electronic device 119 may be, for example, a desktop computer, a portable computing device such as a laptop computer, a smartphone, a peripheral device (e.g., a digital camera, headphones), a tablet device, standalone voice messaging hardware, a wearable device such as a watch, a band, and the like, or any other appropriate device that includes, for example, one or more wireless interfaces, such as WLAN radios, cellular radios, Bluetooth radios, Zigbee radios, near field communication (NFC) radios, and/or other wireless radios. Any of the electronic device 110, the electronic device 115, the electronic device 117, or the electronic device 119 may be, and/or may include all or part of, the electronic system discussed below with respect to FIG. 5.

In FIG. 1, by way of example, the electronic device 110 is depicted as a desktop computer, the electronic device 115 and the electronic device 117 are depicted as tablet devices, and the electronic device 119 is depicted as a smart phone. In one or more implementations, the electronic device 110, the electronic device 115, the electronic device 117, and/or the electronic device 119 may include a voice messaging application and/or a transcription service installed and/or accessible at that electronic device. In one or more implementations, the electronic device 110, the electronic device 115, the electronic device 117, and/or the electronic device 119 may include a camera and/or a microphone and may provide the voice messaging application for exchanging audio streams, video streams, and/or transcriptions over the network 106, such as with a corresponding voice messaging application that is installed and accessible at, for example, one more others of the electronic device 110, electronic device 115, electronic device 117, and/or electronic device 119.

In one or more implementations, one or more of the electronic device 110, the electronic device 115, the electronic device 117, and/or the electronic device 119 may have a voice messaging application installed and accessible at the electronic device, and may not have a transcription service available at that electronic device. In one or more implementations, one or more of the electronic device 110, the electronic device 115, the electronic device 117, and/or the electronic device 119 may not have a voice messaging application installed and available at that electronic device, but may be able to access an electronic voice messaging session without the voice messaging application, such as via a web-based voice messaging application provided, at least in part, by one or more servers.

In one or more implementations, one or more servers such as the server 120 and/or the server 130 may perform operations for managing secure exchange of audio streams and/or video streams between various electronic devices such as the electronic device 110, the electronic device 115, the electronic device 117, and/or the electronic device 119, such as during an electronic voice messaging session (e.g., an audio voice messaging session or a video voice messaging session). In one or more implementations, the server 120 may store account information associated with the electronic device 110, the electronic device 115, the electronic device 117, the electronic device 119, and/or users of those devices. In one or more implementations, one or more servers such as the server 130 may provide resources (e.g., web-based application resources), for managing connections to and/or communications within the electronic voice messaging session. In one or more implementations, one or more servers such as the server 130 may store information indicating one or more capabilities of the electronic devices that are participants in an electronic voice messaging session, such as device transcription capabilities of the participant devices and/or other device capability information.

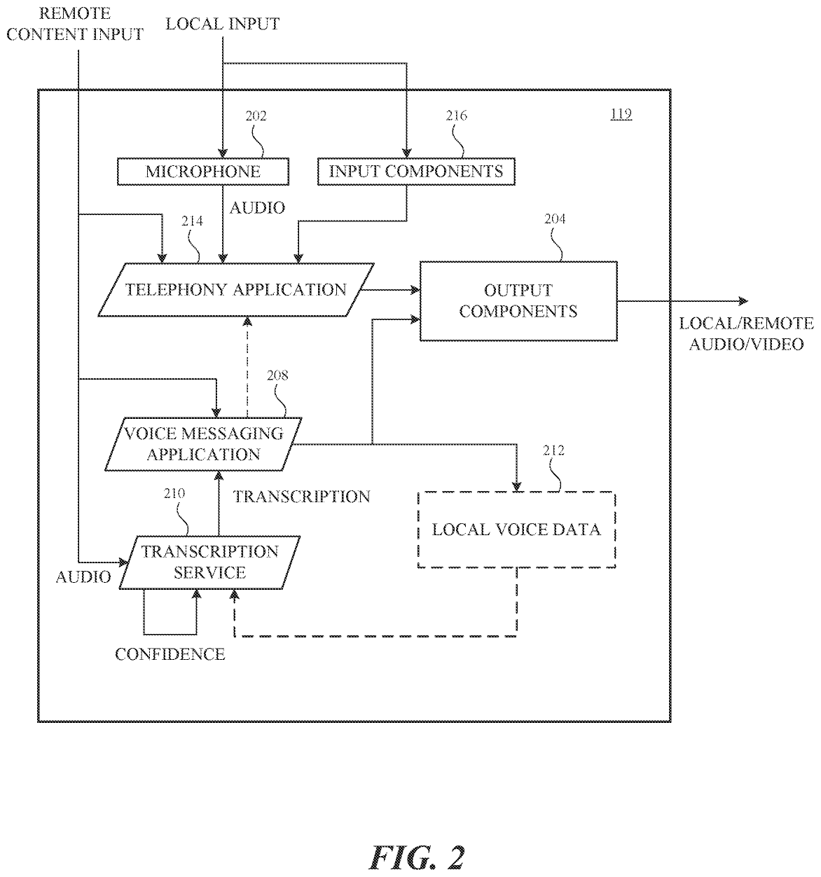

FIG. 2 illustrates a schematic view of an electronic device 119 for providing dynamic presentation of a transcription during an electronic voice messaging session in accordance with one or more implementations. In the example of FIG. 2, rectangular boxes are used to indicate hardware components, and trapezoidal boxes are used to indicate software processes that may be executed by one or more processors of the electronic device.

As shown in FIG. 2, an electronic device, such as electronic device 119, may include one or more microphones such as microphone 202, and output components 204 (e.g., a display and/or one or more speakers). FIG. 2 also illustrates a voice messaging application 208 and a transcription service 210 that may be installed and/or running at the electronic device 119. In the example, of FIG. 2, the transcription service 210 is shown separately from the voice messaging application 208 (e.g., as a system process at the electronic device 119). However, in other implementations, the transcription service 210 may be provided as a part of the voice messaging application 208.

FIG. 2 also illustrates a telephony application 214 running at the electronic device 119. In the example, of FIG. 2, the voice messaging application 208 is shown separately from the telephony application 214. However, in other implementations, the voice messaging application 208 may be provided as part of the telephony application 214. The telephony application 214 may refer to the capability of the electronic device 119 to make and receive voice calls, send and receive text messages, and access various communication features. The telephony application 214 can utilize built-in cellular network connectivity of the electronic device 119, allowing users to establish real-time voice communication with other devices through traditional phone calls or IP services like Voice over IP (VoIP). Additionally, the telephony application 214 can enable text-based communication through SMS (Short Message Service) or other messaging applications. The telephony application 214 can provide an audio output corresponding to the audio stream and/or a video output corresponding to the video stream for output via the output components 204 (e.g., the audio stream being output via an output device such as one or more speakers of, or connected to, the electronic device 119 and/or the video stream being output via a display device of the electronic device 119).

As shown in FIG. 2, local input (e.g., audio input to the microphone 202) may be received by the telephony application 214 running on the electronic device 119. For example, the user of the electronic device 119 may speak into the microphone 202.

In one or more implementations, the voice messaging application 208 may act as a virtual answering service by accepting incoming calls on behalf of the electronic device 119. When a call comes in, the voice messaging application 208 can take over and prompts the caller to leave a voice message. For example, the voice messaging application 208 can intercept incoming calls received at the electronic device 119. This may be achieved by configuring the settings on the electronic device 119 to direct calls to the voice messaging application 208. In one or more implementations, the voice message application 208 intercepts the incoming calls prior to a voicemail service of a telephone service provider establishes a voice messaging session with the incoming call.

Using intuitive prompts or automated instructions, the caller can be guided through the process of recording their voice message. For example, when a call is received at the electronic device 119, the voice messaging application 208 can take control and present the caller with pre-recorded or synthesized prompts. These prompts can inform the caller that the recipient (e.g., a user of the electronic device 119) is currently unavailable and instruct them to leave a voice message. The voice messaging application 208 can capture the audio input, convert the audio input into a digital audio file, and stores the digital audio file as local voice data 212 for later retrieval by the voice messaging application 208 and/or the transcription service 210. This service can ensure that callers can leave voice messages directly on the electronic device 119 even when the user of the electronic device 119 is unavailable or unable to answer the call.

As shown in FIG. 2, the voice messaging application 208 may receive remote content input (e.g., remote audio content and/or remote video content) from one or more other electronic devices, such as the electronic device 110, the electronic device 115, and/or the electronic device 117, during an electronic voice messaging session. FIG. 2 also illustrates how, in some operational circumstances in one or more implementations, remote content (e.g. an audio stream from one or more other electronic devices, such as the electronic device 110, the electronic device 115, and/or the electronic device 117 during an electronic voice messaging session) is provided to the transcription service 210. In one or more implementations, the transcription service 210 can generate a transcription of the audio portion of the remote content input, and provide the transcription of the audio portion of the remote content input for display by the output components 204 (e.g. dynamically displayed on a display device of the electronic device 119 during at least a portion of an electronic voice messaging session or during entirety of the electronic voice messaging session). In one or more implementations, the transcription can be provided to the output components 204 for transmission to one or more of the electronic device 110, the electronic device 115, and/or the electronic device 117 for display and/or storage in a privacy-protected manner at that device. In one or more other implementations, the voice messaging application 208 may tag the transcription with an indication that causes the display of the transcription to be suppressed at the receiving device based on a type of device the transcription is being relayed to (e.g., if one of the electronic devices in the network environment 100 as the receiving device is an electronic device integrated in a vehicle).

In one or more implementations, the transcription service 210 may also provide the transcription to the voice messaging application 208. In one or more other implementations, the transcription can be generated by the voice messaging application 208 (e.g., the transcription service 210 may be implemented as an integral part of the voice messaging application 208). In one or more implementations, the transcription can be generated and transmitted in segments, so that each segment of the transcription can be displayed at the electronic device 119 as the corresponding audio input is being provided to the electronic device 119. The transcription service 210 or the voice messaging application 208 may generate time information for the transcription. The time information can be used to synchronize the transcription with the remote content input audio/video when the remote content input audio/video and the transcription are rendered at the electronic device 119. For example, a time at which the transcription (or a segment thereof) was generated, or a time at which the transcribed audio input (or a segment thereof) was provided for display at the electronic device 119 can be provided along with a time at which an audio stream (or a segment thereof) of the remote content input is received at the electronic device 119, and the time corresponding to the transcription and the time corresponding to the audio input can be used to synchronize the transcription and the corresponding audio stream in which a user speaks the words in the transcription.

As illustrated in FIG. 2, the transcription service 210 may use local voice data 212 to aid in generating a transcription of an audio portion of the remote content input in one or more implementations. For example, the local voice data 212 may include one or more stored and/or learned attributes (e.g., frequency characteristics, commonly used words or phrases, and/or voice models at the electronic device 119 that have been trained on voice inputs from the user of the electronic device 119 and/or a user of the electronic device 110, the electronic device 115, and/or the electronic device 117) of the voice of the user of the electronic device 119 and/or the user of the electronic device 110, the electronic device 115, and/or the electronic device 117. In this way, the transcription service 210 at the electronic device 119 may leverage its own preexisting knowledge of the user of the electronic device 119 and/or a user of the electronic device 110, the electronic device 115, and/or the electronic device 117 to generate transcriptions of spoken input by that user that are higher quality than would be otherwise possible by a general transcription service for generic voices (e.g., a transcription service provided by a server or another device of another user).

As shown in FIG. 2, the transcription service 210 may generate a confidence (e.g., a confidence score) for a transcription (e.g., for a segment of a transcription such as for a set of words spoken during a particular period of time during the electronic voice messaging session). In one or more implementations, the transcription service 210 may determine whether the confidence score exceeds a confidence threshold. In some aspect, the confidence threshold is a predefined value. In other aspects, the confidence threshold may be a user-configured value. Accordingly, the electronic device 119 may display the transcription based on a determination by the transcription service 210 that the confidence score exceeds the confidence threshold. In one or more other implementations, the voice messaging application 208 may compare the confidence score with the confidence threshold to determine whether the transcription should be displayed on the electronic device 119. In one or more implementations, when the confidence is below a threshold, the transcription service 210 may generate an updated transcription with an updated confidence score. If, for example, the electronic device 119 (e.g., the voice messaging application 208 or the transcription service 210) determines that the updated confidence score is greater than the confidence score of the previously generated transcription, the electronic device 119 may display the updated transcription on the electronic device 119.

In one or more implementations, an electronic voice messaging session may refer to a voicemail interaction by way of a temporary connection between the voice messaging application 208 at the electronic device 119 and another electronic device (e.g., the electronic device 110, the electronic device 115, or the electronic device 117) serving as the caller via the network 106 and/or the network 150. During the electronic voice messaging session, the caller can record their voice message, which is then stored as the local voice data 212 at the electronic device 119 and made available for dynamic display on the electronic device 119 for a user of the electronic device 119.

In one or more implementations, the voice messaging application 208 can store in a privacy-protected manner and synchronize voicemail messages on a cloud network, enabling users to access their voicemail messages on multiple devices. By utilizing the cloud network, voicemail messages can be securely stored in the cloud network and synchronized across various devices associated with the user's account. The synchronization process ensures that voicemail messages are consistently updated and available for retrieval, providing a seamless and unified voicemail experience across multiple devices.

FIG. 2 also shows input components 216 to receive input from a user of the electronic device 119. For example, the electronic device can provide input options such as phone call handover option (e.g., for switching from an electronic voice messaging session to a voice communication session via the telephony application 214). When a user of the electronic device 119 selects the phone call handover option via the input components 216, the call intercepted by the voice messaging application 208 to capture and record the audio stream of the voice message can be transitioned over to the telephony application 214, such as via an inter-process communication, and allow the audio stream of the call to resume by way of audio output via the output components 204 so that the user of the electronic device 119 can instead communicate live with the caller in a voice communication session.

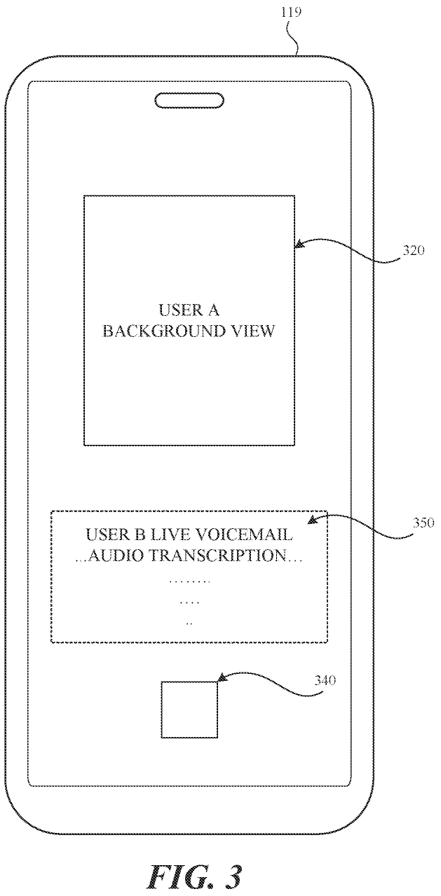

FIG. 3 illustrates a schematic diagram showing an exemplary user interface view in which a transcription is displayed dynamically on an electronic device 119 during an electronic voice messaging session using a voice messaging application, such as voice messaging application 208 running at the electronic device 119 in accordance with one or more implementations. In the example of FIG. 3, the dynamic presentation of the transcription is represented as scrolling text on a display of the electronic device 119, for illustrative purposes. As shown in FIG. 3, during an electronic voice messaging session, the voice messaging application can provide, for display, a scrolling transcription 350.

In the example of FIG. 3, a user background view 320 covers substantially the entire display of electronic device 119 with a portion being covered by the scrolling transcription 350. However, this is merely illustrative and other arrangements of the user background view 320 and the scrolling transcription 350 can be provided (e.g., two equally sized side-by-side or top-bottom video stream views).

As shown in FIG. 3, the electronic device 119 may also provide input options such as phone call handover option 340 (e.g., for switching from an electronic voice messaging session to a voice communication session via the telephony application 214). When a user of the electronic device 119 selects the phone call handover option 340, the call intercepted by the voice messaging application 208 to capture and record the audio stream of the voice message can be transitioned over to the telephony application 214 and allow the audio stream of the call to resume by way of audio output via the output components 204 so that the user of the electronic device 119 can instead communicate live with the caller in a voice communication session. In one or more other implementations, the handover between the electronic voice messaging session and the voice communication session may be a two-step process, 1) where the voice messaging application 208 may first send a segment of the audio stream of the recorded voice message to the output components 204 in response to a user of the electronic device 119 selecting the phone call handover option 340, so that the user can ascertain the tone or context of the message before deciding whether to answer the call, thereby enabling the use of the electronic device 119 to make an informed decision regarding call acceptance based on the audio transcript; and 2) the voice messaging application 208 facilitates the transition to the voice communication session with the telephony application 214 in response to the user confirming selection of the phone call handover option 340.

As shown in FIG. 3, during the electronic voice messaging session, the scrolling transcription 350 may be displayed by the voice messaging application. In the example of FIG. 3, the scrolling transcription 350 is a transcription of audio content that is being received as input to the electronic device (e.g., the electronic device 119) of a user of one of the electronic device 110, the electronic device 115 or the electronic device 117. The transcription may be a running transcription that includes text corresponding to segments (e.g., sentences, phrases, words, groups of words, etc.) of an audio input to the electronic device 119 (e.g., words spoken by another user into a microphone associated with one of the electronic device 110, the electronic device 115 or the electronic device 117), the text for each segment of audio input displayed as (e.g., in synchronization with) the other user speaks that segment during the electronic voice messaging session.

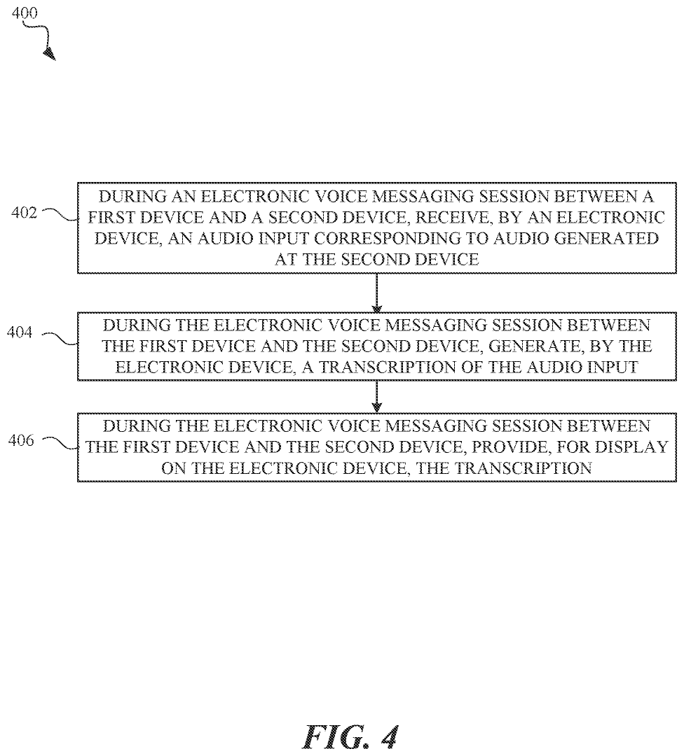

As described in further detail herein (e.g., in connection with FIGS. 2 and 4), the electronic device 119 may also receive and display updates to the scrolling transcription 350 during the electronic voice messaging session. For example, while a segment of the transcription is still displayed in the scrolling transcription 350, the electronic device (e.g., electronic device 119) that generated the transcription may generate an update to that segment of the transcription (e.g., a correction to the segment of the transcription based on an improved confidence for the update, such as an improved transcription using words or other context received after the audio corresponding to the segment was received) and provide the update for display on the electronic device 119. For example, the electronic device 119 may modify the currently displayed segment of the transcription in the scrolling transcription 350 according to the update. The update may change a word or several words in the segment to an updated word that makes more sense in the overall transcription of the segment.

In various examples, the transcription can be generated responsive to a reduction in bandwidth for a voice communication session via the telephony application 214. For example, one or more of the electronic devices and/or a server (e.g., the group of servers 160) relaying information for the voice communication session may determine that the bandwidth for one or more of the electronic devices has become too low for exchanging audio and/or video data, and a transcription may be provided in lieu of the audio and/or video data (e.g., until an increase in bandwidth is detected).

FIG. 4 illustrates a flow diagram of an example process 400 for providing dynamic presentation of a transcription during an electronic voice messaging session in accordance with one or more implementations. For explanatory purposes, the process 400 is primarily described herein with reference to the components of FIG. 1 (particularly with reference to electronic device 117), which may be executed by one or more processors of the electronic device 117 of FIG. 1. However, the process 400 is not limited to the electronic device 117, and one or more blocks (or operations) of the process 400 may be performed by one or more other components of other suitable devices, such as one or more of the electronic device 110, the electronic device 115, the electronic device 119, and/or one or more servers such as the server 120 and/or the server 130. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

In the example process 400, during an electronic voice messaging session between a first device (e.g., electronic device 119) and a second device (e.g., one of electronic device 110, electronic device 115, or electronic device 117), at block 402, the first device receives an audio input corresponding to audio generated at the second device. For example, the first device may receive the audio input, which may correspond to a user of the second device speaking into a microphone of (or connected to) the second device. For example, the electronic voice messaging session may be an audio voice messaging session, such as a call intercepted by a voice messaging application (e.g., voice messaging application 208 as described above in connection with FIG. 2) and prompting a user of the second device to record a voice message. In one or more implementations, during the electronic voice messaging session between the first device and the second device, the first device may determine whether the audio input corresponds to an unknown user of the second device. In some aspects, the transcription of the audio input may be generated in response to a determination that the audio input corresponds to an unknown user of the second device. In some aspects, the audio input is received from the second device over a wireless network. For example, the wireless network may be a cellular network.

At block 404, during the electronic voice messaging session between the first device and the second device, the first device may generate a transcription of the audio input. For example, the first device may generate the transcription of the audio input using a transcription service at the first device (e.g., transcription service 210 as described above in connection with FIG. 2). In one or more implementations, the transcription is associated with a confidence score. In some aspects, the confidence score may indicate a likelihood that the transcription represents content in the audio input in its entirety. In one or more other implementations, the first device may determine, during the electronic voice messaging session between the first device and the second device, whether the confidence score exceeds a confidence threshold. In some aspects, the transcription is provided for display on the first device based on a determination that the confidence score exceeds the confidence threshold.

At block 406, during the electronic voice messaging session between the first device and the second device, the first device may provide, for display on the first device, the transcription. In one or more implementations, the first device may send, during the electronic voice messaging session, the transcription of the audio input and an audio stream corresponding to the audio input to a third device associated with a user of the first device for display or storage of the transcription and the audio stream at the third device. In one or more other implementations, the first device may tag the transcription with an indication that causes display of the transcription to be suppressed at the third device based on a device type of the third device.

In one or more implementations, the first device may receive, during the electronic voice messaging session between the first device and the second device, and responsive to the transcription being displayed on the first device, user input indicating a request to transition from the electronic voice messaging session to a voice communication session with the second device. In one or more other implementations, the first device may provide, during the electronic voice messaging session between the first device and the second device, and responsive to the request to transition from the electronic voice messaging session to the voice communication session with the second device, an audio stream corresponding to at least a portion of the audio input for output on the first device prior to the transition. The first device may receive, responsive to the audio stream being provided to the output device of the first device, user input indicating confirmation of the request to transition to the voice communication session with the second device.

Generating the transcription at the electronic device at which the audio input is received (e.g., in contrast to sending an audio stream for transcription at a server or other external transcription service) can be advantageous because local voice data corresponding to the speaker of the audio input can be obtained, learned, and/or stored by the electronic device that receives the audio input, and used to improve the audio transcription. Because this local voice data is maintained locally and privacy-protected at the electronic device, the privacy of the user, the speaker of which the audio input pertains to, can be maintained while leveraging the local voice data for that user to improve the electronic device's ability to generate an accurate and/or complete transcription.

As described herein, aspects of the subject technology may include the collection and processing of privacy-sensitive data on a user's computing device. The present disclosure contemplates that in some instances, this collected data may include personal information data that uniquely identifies or can be used to identify a specific person. Such personal information data can include demographic data, location-based data, online identifiers, telephone numbers, email addresses, voice data, audio data, video data, home addresses, images, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used in providing a video voice messaging session with a transcription. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of video voice messaging with transcription, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 5 illustrates an electronic system 500 with which one or more implementations of the subject technology may be implemented. The electronic system 500 can be, and/or can be a part of, the electronic device 110, the electronic device 115, the electronic device 117, the electronic device 119, the server 120 and/or the server 130 shown in FIG. 1. The electronic system 500 may include various types of computer readable media and interfaces for various other types of computer readable media. The electronic system 500 includes a bus 508, one or more processing unit(s) 512, a system memory 504 (and/or buffer), a ROM 510, a permanent storage device 502, an input device interface 514, an output device interface 506, and one or more network interfaces 516, or subsets and variations thereof.

The bus 508 collectively represents all system, peripheral, and chipset buses that communicatively connect the numerous internal devices of the electronic system 500. In one or more implementations, the bus 508 communicatively connects the one or more processing unit(s) 512 with the ROM 510, the system memory 504, and the permanent storage device 502. From these various memory units, the one or more processing unit(s) 512 retrieves instructions to execute and data to process to execute the processes of the subject disclosure. The one or more processing unit(s) 512 can be a single processor or a multi-core processor in different implementations.

The ROM 510 stores static data and instructions that are needed by the one or more processing unit(s) 512 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a flash drive and its corresponding solid-state drive) may be used as the permanent storage device 502. Like the permanent storage device 502, the system memory 504 may be a read-and-write memory device. However, unlike the permanent storage device 502, the system memory 504 may be a volatile read-and-write memory, such as random-access memory. The system memory 504 may store any of the instructions and data that one or more processing unit(s) 512 may need at runtime. In one or more implementations, the processes of the subject disclosure are stored in the system memory 504, the permanent storage device 502, and/or the ROM 510. From these various memory units, the one or more processing unit(s) 512 retrieves instructions to execute and data to process in order to execute the processes of one or more implementations.

The bus 508 also connects to the input and output device interfaces 514 and 506. The input device interface 514 enables a user to communicate information and select commands to the electronic system 500. Input devices that may be used with the input device interface 514 may include, for example, alphanumeric keyboards and pointing devices (also called “cursor control devices”). The output device interface 506 may enable, for example, the display of images generated by electronic system 500. Output devices that may be used with the output device interface 506 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 508 also couples the electronic system 500 to one or more networks and/or to one or more network nodes, such as the electronic device 115 shown in FIG. 1, through the one or more network interface(s) 516. In this manner, the electronic system 500 can be a part of a network of computers (such as a LAN, a wide area network (“WAN”), or an Intranet, or a network of networks, such as the Internet. Any or all components of the electronic system 500 can be used in conjunction with the subject disclosure.

In accordance with various aspects of the subject disclosure, a device is provided that includes a memory and one or more processors configured to, during an electronic voice messaging session between at least a first device and a second device: receive, by the electronic device, a first audio input; generate a first transcription of the first audio input; and send the first transcription from the electronic device to another device; and, during the electronic voice messaging session and after sending the first transcription: receive a second audio input; generate a second transcription of the second audio input; and send the second transcription to the other device.

In accordance with various aspects of the subject disclosure, a non-transitory computer-readable medium is provided that includes instructions, which when executed by one or more processors, cause the one or more processors to perform operations that include, during an electronic voice messaging session between at least a first device and a second device: receiving, by the first device, a first audio input; generating, by the first device, a first transcription of the first audio input; and sending the first transcription from the first device to the second device; and, during the electronic voice messaging session and after sending the first transcription: receiving, by the first device, a second audio input; generating, by the first device, a second transcription of the second audio input; and sending the second transcription from the first device to the second device.

In accordance with various aspects of the subject disclosure, a method is provided that includes, during an electronic voice messaging session between at least a first device and a second device: receiving, by the first device, a first audio input; generating, by the first device, a first transcription of the first audio input; and sending the first transcription from the first device to the second device; and, during the electronic voice messaging session and after sending the first transcription: receiving, by the first device, a second audio input; generating, by the first device, a second transcription of the second audio input; and sending the second transcription from the first device to the second device.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the phrase “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
during an electronic voice messaging session between a first device and a second device:
receiving, by the first device, an audio input corresponding to audio generated at the second device;
generating, by the first device, a transcription of the audio input; and
providing, for display on the first device, the transcription.

2. The method of claim 1, further comprising, during the electronic voice messaging session between the first device and the second device, determining, by the first device, whether the audio input corresponds to an unknown user of the second device, wherein the transcription of the audio input is generated in response to a determination that the audio input corresponds to an unknown user of the second device.

3. The method of claim 1, wherein the audio input is received from the second device over a wireless network.

4. The method of claim 3, wherein the wireless network is a cellular network.

5. The method of claim 1, further comprising, during the electronic voice messaging session, sending the transcription of the audio input and an audio stream corresponding to the audio input from the first device to a third device associated with a user of the first device for display or storage of the transcription and the audio stream at the third device.

6. The method of claim 5, further comprising tagging the transcription with an indication that causes display of the transcription to be suppressed at the third device based on a device type of the third device.

7. The method of claim 1, wherein the transcription is associated with a confidence score, the confidence score indicating a likelihood that the transcription represents content in the audio input in its entirety, further comprising, during the electronic voice messaging session between the first device and the second device, determining, by the first device, whether the confidence score exceeds a confidence threshold, wherein the transcription is provided for display on the first device based on a determination that the confidence score exceeds the confidence threshold.

8. The method of claim 1, further comprising, during the electronic voice messaging session between the first device and the second device, receiving, by the first device, responsive to the transcription being displayed on the first device, user input indicating a request to transition from the electronic voice messaging session to a voice communication session with the second device.

9. The method of claim 8, further comprising, during the electronic voice messaging session between the first device and the second device:
providing, responsive to the request to transition from the electronic voice messaging session to the voice communication session with the second device, an audio stream corresponding to at least a portion of the audio input prior to the transition to an output device of the first device; and
receiving, by the first device, responsive to the audio stream being provided to the output device of the first device, user input indicating confirmation of the request to transition to the voice communication session with the second device.

10. An electronic device, comprising:
memory; and
one or more processors configured to:
during an electronic voice messaging session between a first device and a second device:
receive, by the first device, an audio input corresponding to audio generated at the second device;
generate, by the first device, a transcription of the audio input; and
provide, for display on the first device, the transcription.

11. The electronic device of claim 10, wherein the one or more processors are further configured to, during the electronic voice messaging session between the first device and the second device, determine, by the first device, whether the audio input corresponds to an unknown user of the second device, wherein the transcription of the audio input is generated in response to a determination that the audio input corresponds to an unknown user of the second device.

12. The electronic device of claim 10, wherein the audio input is received from the second device over a wireless network.

13. The electronic device of claim 12, wherein the wireless network is a cellular network.

14. The electronic device of claim 10, wherein the one or more processors are further configured to, during the electronic voice messaging session, send the transcription of the audio input and an audio stream corresponding to the audio input from the first device to a third device associated with a user of the first device for display or storage of the transcription and the audio stream at the third device.

15. The electronic device of claim 14, wherein the one or more processors are further configured to tag the transcription with an indication that causes display of the transcription to be suppressed at the third device based on a device type of the third device.

16. The electronic device of claim 10, wherein the transcription is associated with a confidence score, the confidence score indicating a likelihood that the transcription represents content in the audio input in its entirety, wherein the one or more processors are further configured to, during the electronic voice messaging session between the first device and the second device, determine, by the first device, whether the confidence score exceeds a confidence threshold, wherein the transcription is provided for display on the first device based on a determination that the confidence score exceeds the confidence threshold.

17. The electronic device of claim 10, wherein the one or more processors are further configured to, during the electronic voice messaging session between the first device and the second device, receive, by the first device, responsive to the transcription being displayed on the first device, user input indicating a request to transition from the electronic voice messaging session to a voice communication session with the second device.

18. The electronic device of claim 17, wherein the one or more processors are further configured to, during the electronic voice messaging session between the first device and the second device:
provide, responsive to the request to transition from the electronic voice messaging session to the voice communication session with the second device, an audio stream corresponding to at least a portion of the audio input prior to the transition; and
receive, by the first device, user input indicating confirmation of the request to transition to the voice communication session with the second device.

19. A non-transitory computer-readable medium storing instructions that, when executed by one or more processors, cause the one or more processors to perform operations comprising:
during an electronic voice messaging session between a first device and a second device:
receiving, by the first device, an audio input corresponding to audio generated at the second device;
generating, by the first device, a transcription of the audio input; and
providing, for display on the first device, the transcription.
